(19) United States
(12) Patent Application Publication
(10) Pub. No.: US 2018/0206415 A1
(43) Pub. Date: Jul. 26, 2018

(54) MULTI-FUNCTIONAL FLOWERPOT

(71) Applicants: Lui Chan, Dongguna-city (CN); GuoQiang Chen, Dongguna city (CN)

(72) Inventors: Lui Chan, Dongguna-city (CN); GuoQiang Chen, Dongguna city (CN)

(73) Assignee: Dongguna City Changping ChangMao Products Factory, Dongguna city (CN)

(21) Appl. No.: 15/410,791

(22) Filed: Jan. 20, 2017

(51) Int. Cl. A01G 9/02; A01G 9/20; F21V 33/00; F21V 23/00; F21V 23/02

(52) U.S. Cl. CPC A01G 9/028; A01G 9/021; A01G 9/20; F21Y 2115/10; F21V 23/001; F21V 23/02; F21V 33/0028

(57) ABSTRACT

A multi-functional flowerpot, comprising: an outer pot body; an inner pot body disposed inside the outer body; the outer pot body and the inner pot body are relatively isolated and can be placed respectively in different items, such as accessories, flowers, perfume. the bottom of the outer pot body is provided with a cavity separated from the outer pot body and the inner pot body, and the cavity can be used for mounting a power circuit, the outer pot body or the inner pot body comprises a luminous body controlled by the power circuit, so that the product has a luminous effect, and further enhance the product quality.

### BACKGROUND OF THE INVENTION

### (1) Technical Field

The present invention relates to a flowerpot or decorative container field, particularly to a flowerpot with two cavities.

### (2) Background Art

The conventional flowerpots or decorative containers are generally made of various materials and normally there is only one cavity in them for storing flowers, decorations and water. However, by now they have mainly been improved in their looks but little in the functions, so it's hard to satisfy the demand of customers.

Due to the lack of improvements in pots, they still have a long way to go. Therefore, I am proposing the following plan for improvement.

### BRIEF SUMMARY OF THE INVENTION

For solving the above-mentioned problems, the present invention provide a multi-functional flowerpot with two cavities.

For achieving the purpose, the present invention adopts the following technical scheme: a multi-functional flowerpot, comprising: an outer pot body; an inner pot body disposed inside the outer body; the outer pot body and the inner pot body having the same opening direction; and a cavity disposed at a bottom of the outer pot body; the inner pot body disposed at the center of the outer pot body, and the inner pot body and the outer pot body having a gap disposed therebetween; the outer pot body being formed with a protrusion portion disposed at the bottom and protruded toward an inner chamber thereof, and the protrusion portion being formed with the cavity disposed at a bottom thereof.

More preferably, wherein the cavity comprises a power circuit disposed therein, and a luminous body disposed in the outer pot body or/and inner pot body and controlled by the power circuit.

More preferably, wherein the cavity comprises a hole disposed between the cavity and the outer pot body or/and inner pot body; the hole is configured for a conducting wire passing therethrough, and the conducting wire is configured to connect the luminous body and the power circuit.

More preferably, wherein the luminous body is an LED light.

More preferably, wherein the outer pot body and the inner pot body are made of transparent material.

More preferably, wherein the inner pot body and the outer pot body are connected in one of the following ways: the inner pot body is glued in the outer pot body; the inner pot body is buckled and fixed in the outer pot body; the outer pot body and the inner pot body are molded into on piece.

More preferably, wherein the inner pot body comprises a cover disposed at an opening thereof.

More preferably, wherein the cover and the inner pot body are connected by a threaded structure, and the cover includes insertion holes disposed thereon.

The advantageous effect of the present invention is: the outer pot body is installed with an inner pot body, the outer pot body and the inner pot body are relatively isolated and can be placed respectively in different items, such as accessories, flowers, perfume. Further, according to the present invention, the bottom of the outer pot body is provided with a cavity separated from the outer pot body and the inner pot body, and the cavity can be used for mounting a power circuit, the outer pot body or the inner pot body comprises a luminous body controlled by the power circuit, so that the product has a luminous effect, and further enhance the product quality.

### BRIEF DESCRIPTION OF THE SEVERAL VIEWS OF THE DRAWING(S)

FIG. 1 is a schematic view of a first embodiment of the present invention;

FIG. 2 is a schematic view of a second embodiment of the present invention;

FIG. 3 is a schematic view of a third embodiment of the present invention;

FIG. 4 is a schematic view of a fourth embodiment of the present invention;

### DETAILED DESCRIPTION OF THE INVENTION

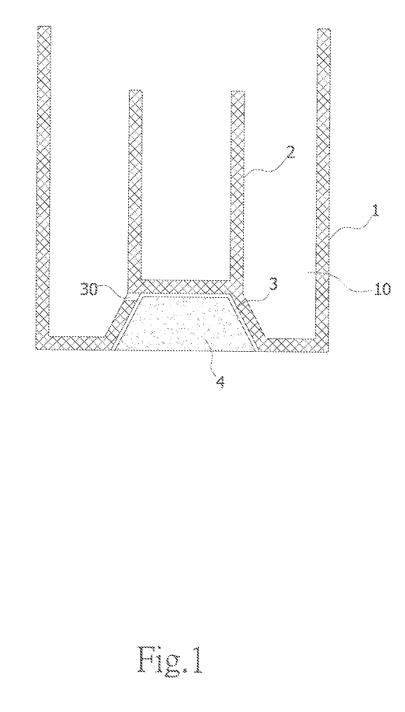

FIG. 1 is a first embodiment of the present invention, a multi-functional flowerpot, comprising: an outer pot body (1); an inner pot body (2) disposed inside the outer body (1); the outer pot body (1) and the inner pot body (2) having the same opening direction; and a cavity (3) disposed at a bottom of the outer pot body (1); the inner pot body (2) disposed at the center of the outer pot body (1), and the inner pot body (2) and the outer pot body (1) having a gap (10) disposed therebetween.

The outer pot body (1) being formed with a protrusion portion disposed at the bottom and protruded toward an inner chamber thereof, and the protrusion portion being formed with the cavity (3) disposed at a bottom thereof. The cavity (3) is relatively isolated from the outer pot body (1) and the inner pot body (2) and can be used for mounting a power circuit (4).

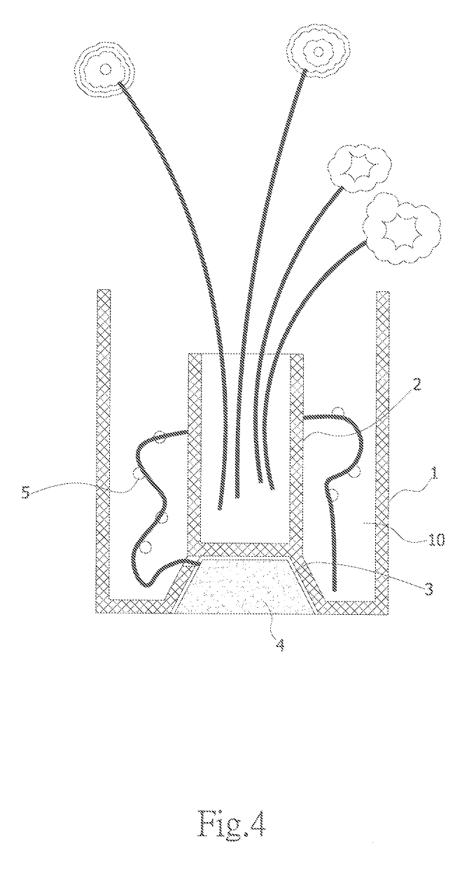

Referring to FIG. 4, wherein the outer pot body (1) or the inner pot body (2) comprises a luminous body (5) which is LED string lights. Wherein the cavity (3) comprises a hole (30) disposed between the cavity (30) and the outer pot body (1) or/and inner pot body (2); the hole (30) is configured for a conducting wire passing therethrough. When in use, the power circuit (4) is not exposed to the possibility of aqueous solution in the outer pot body (1) or the inner pot body (2) as long as the hole (30) is sealed.

Referring to FIG. 4, if the power circuit (4) is provided in the cavity (3), the luminous body (5) controlled by the power circuit (4) may be provided in the outer pot body (1) or the inner pot body (2), and the luminous body electrically connected with the power circuit (4). The luminous body (5) may be an LED light. According to different needs, the luminous body (5) can either be ordinary LED light or special LED light of which the color may be changed by the power circuit (4) in different cases. The power circuit (4) may also employ a voice-activated circuit that triggers the power circuit (4) by sound.

The power circuit (4) has an integrated design in which a power source, a power supply circuit board and a switch are provided. The light emission effect of the luminous body (5) and the operation state can be controlled by the power circuit (4).

The outer pot body (1) and the inner pot body (2) can be formed by one piece of transparent material, for example, glass, plastic or the like. The outer pot body (1) is higher than or equal to the inner pot body (2), and has the advantage that when the inner pot body (2) contains an aqueous solution, the aqueous solution will not flow out of the pot. Of course, if necessary, the design of the inner pot body (2) is higher than the outer pot body (1), and is not limited thereto.

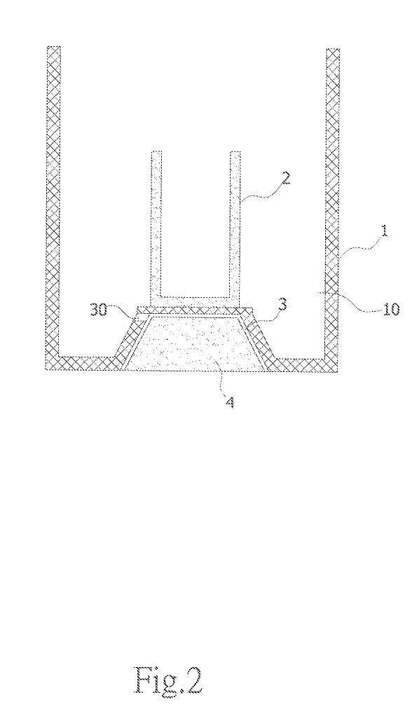

Referring to FIG. 2, which is a second embodiment, the second embodiment differs from the first embodiment in that the inner pot body (2) and the outer pot body (1) are made separately in the second embodiment, and are then bonded by glue, or the inner pot body (2) is fixed in the outer pot body (1) in a manner of buckle connection. The advantages of this method are easy to manufacture, and the materials for manufacturing the outer pot body (1) and the inner pot body (2) can be selected as necessary.

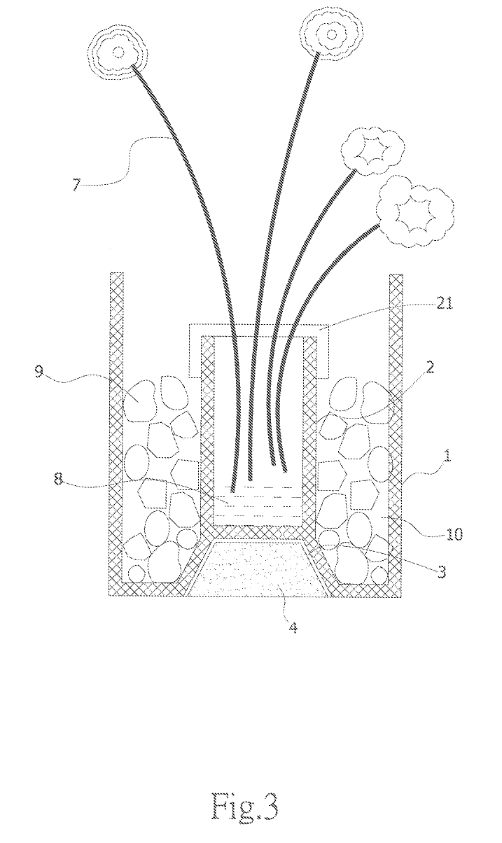

As shown in FIG. 3, this is a third embodiment of the present invention, The third embodiment is different from the first and second embodiments described above in that the opening of the inner pot body (2) is provided with a cover (21) which can prevent not only outside substances from entering into the inner pot body (2) but also may be provided with a plurality of insertion holes for fixing branch-shaped objects such as plants, flowers, ornaments, etc., And if it is necessary to replace the flowers and plants, it is very convenient to remove the cover (21) from the inner pot body (2) directly.

The third embodiment of the present invention can be used as a general flowerpot in which the inner pot body (2) can be provided with flowers or ornaments. If the flowers or plants are real, users can put some water (8) in the inner pot body (2) to keep the plants grow. If the flowers or plants are artificial, users can put some perfume in the inner pot body (2) with decorations (9) in the outer pot body (1) to enhance the overall beauty of the product.

Referring to FIG. 4 for a fourth embodiment, this embodiment has a light-emitting effect. The LED luminous body (5) is provided in the outer pot body (1) or/and the inner pot body (2). The LED light can either be ordinary LED lights or special ones of which the color may be changed by the power circuit (4). The power circuit (4) may also employ a voice-activated circuit that triggers the power circuit (4) by sound.

The lights 5 can either be LED string lights or SMD LED lights integrated on the wall of the outer pot body (1) or inner pot body (2).

The present invention has advantages as follows:

1. It may be generally used, with flowers or plants in the inner pot body (2) and some decorations in the outer pot body 1.

2. It can be lightened up by the luminous body (5) in the outer pot body (1) and inner pot body (2), which are controlled by the power circuit (4). In different cases, the luminous body (5) may be special LED lights of which the color may be changed or voice-activated LED lights.

3. Users can decorate the outer pot body (1) and change them anytime.

4. Users can put some water (when putting flowers) or perfume (when putting artificial flowers) in the inner pot body (2) as needed, and change the perfume anytime. Meanwhile, the cover (21) on the inner pot body (2) is able to keep the perfume from volatilizing and thus keep the smell. Also, the lid (21) can be used for fixing the artificial flowers in their places, which can be changed as needed.

The above only describes some exemplary embodiments of the present invention. Those having ordinary skills in the art may also make many modifications and improvements without departing from the conception of the invention, which shall all fall within the protection scope of the invention.

We claim:

1. A multi-functional flowerpot, comprising:
an outer pot body (1); an inner pot body (2) disposed inside the outer body (1); the outer pot body (1) and the inner pot body (2) having the same opening direction; and a cavity (3) disposed at a bottom of the outer pot body (1); the inner pot body (2) disposed at the center of the outer pot body (1), and the inner pot body (2) and the outer pot body (1) having a gap (10) disposed therebetween;
the outer pot body (1) being formed with a protrusion portion disposed at the bottom and protruded toward an inner chamber thereof, and the protrusion portion being formed with the cavity (3) disposed at a bottom thereof.

2. The multi-functional flowerpot according to claim 1, wherein the cavity (3) comprises a power circuit (4) disposed therein, and a luminous body (5) disposed in the outer pot body (1) or/and inner pot body (2) and controlled by the power circuit (4).

3. The multi-functional flowerpot according to claim 1, wherein the cavity (3) comprises a hole (30) disposed between the cavity (30) and the outer pot body (1) or/and inner pot body (2); the hole (30) is configured for a conducting wire passing therethrough, and the conducting wire is configured to connect the luminous body (5) and the power circuit (4).

4. The multi-functional flowerpot according to claim 3, wherein the luminous body (5) is an LED light.

5. The multi-functional flowerpot according to claim 1, the outer pot body (1) and the inner pot body (2) are made of transparent material.

6. The multi-functional flowerpot according to claim 1, wherein the inner pot body (2) and the outer pot body (1) are connected in one of the following ways: the inner pot body (2) is glued in the outer pot body (1); the inner pot body (2) is buckled and fixed in the outer pot body (1); the outer pot body (1) and the inner pot body (2) are molded into on piece.

7. The multi-functional flowerpot according to claim 1, wherein the inner pot body (2) comprises a cover (21) disposed at an opening thereof.

8. The multi-functional flowerpot according to claim 1, wherein the cover (21) and the inner pot body (2) are connected by a threaded structure, and the cover (21) includes insertion holes disposed thereon.
